(19) United States
(12) Patent Application Publication
(10) Pub. No.: US 2026/0210872 A1
(43) Pub. Date: Jul. 23, 2026

(54) INVERSION DEVICE, IMAGING DEVICE, INVERSION METHOD, AND IMAGING METHOD

(71) Applicant: TOKUYAMA CORPORATION, Yamaguchi (JP)

(72) Inventors: Shinya UESUGI, Yamaguchi (JP); Masahiro KOUZAKI, Yamaguchi (JP); Masayoshi NISHIKAWA, Yamaguchi (JP)

(21) Appl. No.: 19/141,244

(22) PCT Filed: Dec. 20, 2023
(86) PCT No.: PCT/JP2023/045622

§ 371 Date: Jun. 19, 2025

(30) Foreign Application Priority Data
Feb. 6, 2023 (JP) 2023-016440

(51) Int. Cl. G01N 21/88; B65G 47/252

(52) U.S. Cl. CPC G01N 21/8851; B65G 47/252; G01N 2021/8854; G01N 2021/889

(57) ABSTRACT

In order to capture an image of polysilicon, polysilicon varying in shape and/or size is inverted. An inversion device (3) includes: a first sandwiching part (31) including a first elastically deforming part (311) that elastically deforms; a second sandwiching part (32) including a second elastically deforming part (321) that elastically deforms; and an inversion mechanism (33A, 33B) that, for capturing of an image of polysilicon (S), inverts the polysilicon (S) in a sandwiched state in which the polysilicon (S) is sandwiched between the first elastically deforming part (311) and the second elastically deforming part (321).

### TECHNICAL FIELD

The present invention relates to an inversion device, an image capturing device, an inversion method, and an imaging capturing method.

### BACKGROUND ART

Patent Literature 1 discloses a method for classifying polycrystalline silicon, in which an image is generated by capturing of an image of a silicon rod or a silicon chunk, and the silicon rod or the silicon chunk is classified on the basis of the image thus generated.

### CITATION LIST

### Patent Literature

[Patent Literature 1]

Published Japanese Translation of PCT International Application, Tokuhyo, No. 2022-537014

### SUMMARY OF INVENTION

### Technical Problem

The method for classifying polycrystalline silicon disclosed in Patent Literature 1 has a problem that, in a case of capturing an image of a silicon rod or a silicon chunk provided on a predetermined placement surface, it is not possible to capture an image of a portion of the silicon rod or the silicon chunk which portion faces the placement surface. It is an object of an aspect of the present invention that, in order to capture an image of polysilicon, polysilicon varying in shape and/or size is inverted.

### Solution to Problem

In order to attain the object, an inversion device in accordance with an aspect of the present invention includes: a first sandwiching part including a first elastically deforming part that elastically deforms; a second sandwiching part including a second elastically deforming part that elastically deforms; and an inversion mechanism that, in order to capture an image of polysilicon, inverts the polysilicon in a sandwiched state in which the polysilicon is sandwiched between the first elastically deforming part and the second elastically deforming part.

An image capturing device in accordance with an aspect of the present invention includes: a first sandwiching part including a first elastically deforming part that elastically deforms; a second sandwiching part including a second elastically deforming part that elastically deforms; an inversion mechanism that inverts polysilicon in a sandwiched state in which the polysilicon is sandwiched between the first elastically deforming part and the second elastically deforming part; and an image capturing part capable of capturing an image of the polysilicon inverted by the inversion mechanism.

An inversion method in accordance with an aspect of the present invention includes: a sandwiching step of sandwiching polysilicon between a first elastically deforming part that is included in a first sandwiching part and elastically deforms and a second elastically deforming part that is included in a second sandwiching part and elastically deforms; and an inversion step of, in order to capture an image of the polysilicon, inverting the polysilicon in a sandwiched state in which the polysilicon is sandwiched by the sandwiching step.

An image capturing method in accordance with an aspect of the present invention includes: a sandwiching step of sandwiching polysilicon between a first elastically deforming part that is included in a first sandwiching part and elastically deforms and a second elastically deforming part that is included in a second sandwiching part and elastically deforms; an inversion step of inverting the polysilicon in a sandwiched state in which the polysilicon is sandwiched by the sandwiching step; and an image capturing step of capturing an image of the polysilicon inverted by the inversion step.

### Advantageous Effects of Invention

An aspect of the present invention makes it possible to, in order to capture an image of polysilicon, invert polysilicon varying in shape and/or size.

### BRIEF DESCRIPTION OF DRAWINGS

FIG. 1 is a view schematically illustrating a configuration of an image capturing device in accordance with Embodiment 1 of the present invention.

FIG. 2 is a view for describing operation of an inversion device included in the image capturing device illustrated in FIG. 1.

FIG. 3 is a view for describing operation of the inversion device included in the image capturing device illustrated in FIG. 1.

FIG. 4 is a view illustrating configurations of a dome part, image capturing parts, and irradiation parts included in the image capturing device illustrated in FIG. 1.

FIG. 5 is a view illustrating configurations of a dome part, image capturing parts, and irradiation parts included in an image capturing device in accordance with Embodiment 2 of the present invention.

FIG. 6 is a view schematically illustrating a configuration of an image capturing device in accordance with Embodiment 3 of the present invention.

### DESCRIPTION OF EMBODIMENTS

### Embodiment 1

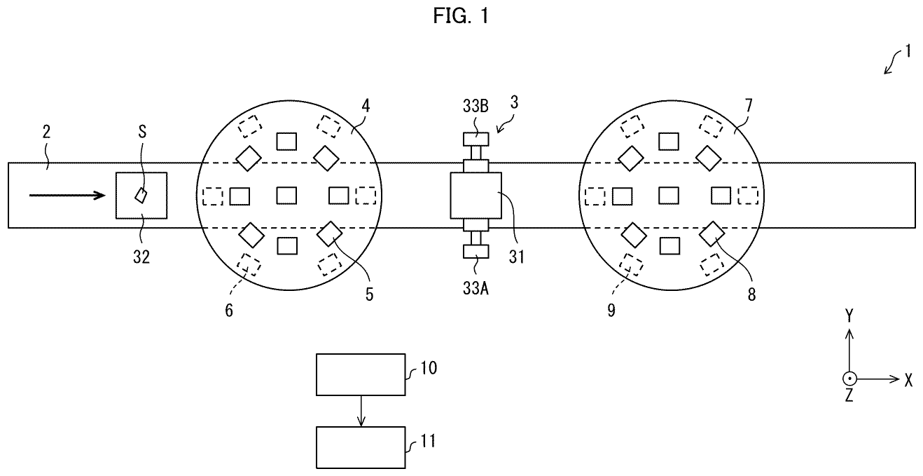

FIG. 1 is a view schematically illustrating a configuration of an image capturing device 1 in accordance with Embodiment 1 of the present invention. In FIG. 1, a direction in which a conveyance mechanism 2 extends is an x-axis direction, a direction from the conveyance mechanism 2 toward a dome part 4 is a z-axis direction, and a direction orthogonal to both the x-axis direction and the z-axis direction is a y-axis direction. The x-axis direction and the z-axis direction are directions orthogonal to each other. The definitions of the x-axis direction, the y-axis direction, and the z-axis direction described here also apply to the other drawings.

### <Configuration of Image Capturing Device 1>

As illustrated in FIG. 1, the image capturing device 1 includes the conveyance mechanism 2, an inversion device 3, dome parts 4 and 7, image capturing parts 5 and 8, irradiation parts 6 and 9, and a control section 10. The image capturing device 1 is a device for determining a surface state, a shape, and a size of polysilicon S by capturing an image of the polysilicon S. The polysilicon S is disposed on a first sandwiching part 31 or a second sandwiching part 32 of the inversion device 3. A plurality of pieces of polysilicon S may be disposed on the first sandwiching part 31 or the second sandwiching part 32. The number of pieces of polysilicon S disposed on the first sandwiching part 31 or the second sandwiching part 32 is, for example, one or two.

The polysilicon S subjected to an image capturing device in accordance with an aspect of the present invention is crushed polysilicon obtained by crushing a silicon rod or a silicon chunk which has been produced by a known method. A shape of the polysilicon S encompasses a variety of shapes such as a flat shape and a fist-like shape. A size of the polysilicon S can be selected as appropriate depending on the purpose, and the polysilicon S ordinarily has a long diameter selected within a range of not less than 10 mm and not more than 150 mm.

Further, by carrying out surface purification by etching, it is possible to obtain highly pure crushed polysilicon as the crushed polysilicon. Both crushed polysilicon that has been subjected to surface purification and crushed polysilicon that has not been subjected to surface purification are usable as the polysilicon S subjected to an image capturing device in accordance with an aspect of the present invention.

The conveyance mechanism 2 conveys the polysilicon S in a positive x-axis direction by conveying the first sandwiching part 31 or the second sandwiching part 32 in the positive x-axis direction. On a positive side of the conveyance mechanism 2 in the z-axis direction, the inversion device 3 and the dome parts 4 and 7 are disposed. The dome part 4, inversion mechanisms 33A and 33B of the inversion device 3, and the dome part 7 are disposed in this order in the positive x-axis direction.

### <Configuration of Inversion Device 3>

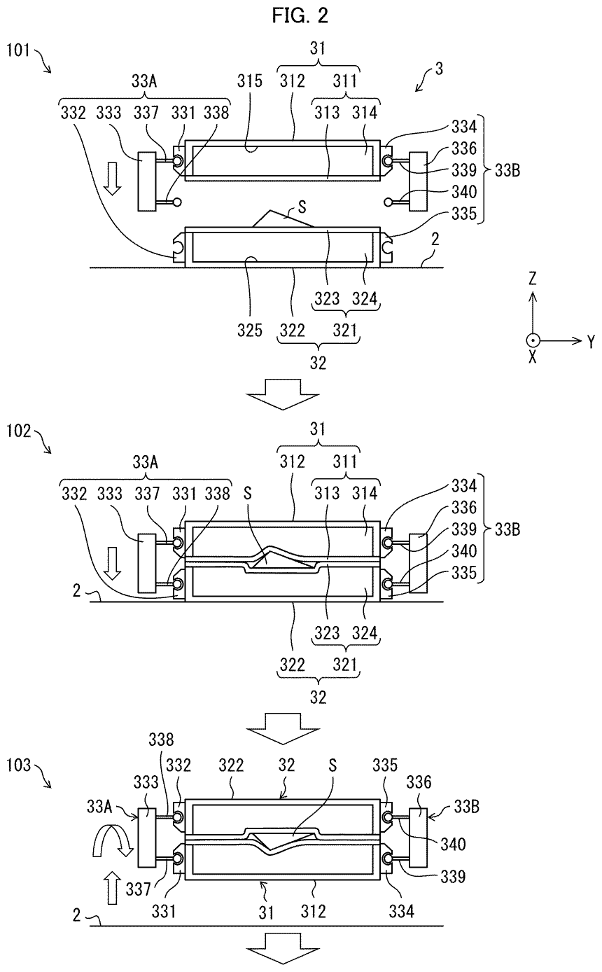

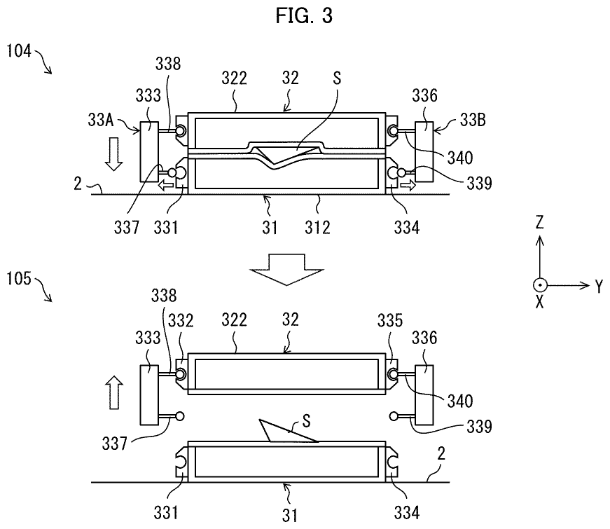

FIGS. 2 and 3 are diagrams for describing operation of the inversion device 3 included in the image capturing device 1 illustrated in FIG. 1. The reference numeral 101 in FIG. 2 indicates a view illustrating a case in which the second sandwiching part 32 on which the polysilicon S is disposed has been conveyed by the conveyance mechanism 2 from the position of the dome part 4 to the position at which the inversion mechanisms 33A and 33B are provided on the conveyance mechanism 2 in FIG. 1. The reference numeral 102 in FIG. 2 indicates a view illustrating a case in which a transition has been made from a state illustrated in the reference numeral 101 in FIG. 2 to a sandwiched state in which the polysilicon S is sandwiched between the first sandwiching part 31 and the second sandwiching part 32.

The reference numeral 103 in FIG. 2 indicates a view illustrating a case in which a transition has been made from a state illustrated in the reference numeral 102 in FIG. 2 to a state in which the polysilicon S has been inverted by the inversion mechanisms 33A and 33B. The reference numeral 104 in FIG. 3 indicates a view illustrating a case in which the inversion mechanisms 33A and 33B have moved in a negative z-axis direction from the state illustrated in the reference numeral 103 in FIG. 2. The reference numeral 105 in FIG. 3 indicates a view illustrating a case in which a transition has been made from a state illustrated in the reference numeral 104 in FIG. 3 to a state in which the sandwiched state of the polysilicon S has been released.

As illustrated in the reference numeral 101 in FIG. 2, the inversion device 3 includes the first sandwiching part 31, the second sandwiching part 32, and the inversion mechanisms 33A and 33B. The first sandwiching part 31 includes a first elastically deforming part 311 and a support member 312, and the second sandwiching part 32 includes a second elastically deforming part 321 and a support member 322.

The first elastically deforming part 311 elastically deforms, and includes a first elastic sheet 313 and a first buffer material 314. The support member 312 is a member that supports the first elastically deforming part 311, and is, for example, a polyvinyl chloride resin (PVC). The support member 312 has a recess 315 formed therein. The first buffer material 314 is provided in the recess 315, and the recess 315 is blocked by the first buffer material 314.

The first elastic sheet 313 is, for example, adhesively secured to the support member 312 so as to cover the first buffer material 314. Note that the first elastic sheet 313 is not adhesively secured to the first buffer material 314. This is because a frequency of replacement of the first elastic sheet 313 differs from a frequency of replacement of the first buffer material 314, and also because a rebound resilience rate of the first elastic sheet 313 is higher than a rebound resilience rate of the first buffer material 314. Note that securing of the first elastic sheet 313 to the support member 312 is achieved by a method which is not limited to adhesive securing and may be, for example, a securing method involving a presser board or the like. The first buffer material 314 is, for example, adhesively secured to a bottom surface of the recess 315.

The second elastically deforming part 321 elastically deform, and includes a second elastic sheet 323 and a second buffer material 324. The support member 322 is a member that supports the second elastically deforming part 321, and is, for example, a polyvinyl chloride resin. The support member 322 has a recess 325 formed therein. A second buffer material 324 is provided in the recess 325, and the recess 325 is blocked by the second buffer material 324.

The second elastic sheet 323 is, for example, adhesively secured to the support member 322 so as to cover the second buffer material 324. Note that the second elastic sheet 323 is not adhesively secured to the second buffer material 324. This is because a frequency of replacement of the second elastic sheet 323 differs from a frequency of replacement of the second buffer material 324, and also because a rebound resilience rate of the second elastic sheet 323 is higher than a rebound resilience rate of the second buffer material 324. Note that securing of the second elastic sheet 323 to the support member 322 is achieved by a method which is not limited to adhesive securing and may be, for example, a securing method involving a presser board or the like. The second buffer material 324 is, for example, adhesively secured to a bottom surface of the recess 325.

The inversion mechanisms 33A and 33B, in order to capture an image of the polysilicon S by the image capturing parts 8, invert the polysilicon S in a sandwiched state in which the polysilicon S is sandwiched between the first elastically deforming part 311 and the second elastically deforming part 321.

The inversion mechanism 33A includes a first holding part 331, a second holding part 332, a rotation part 333, and movement members 337 and 338. The first holding part 331 is a member which is provided on a side wall of the support member 312 and which holds the movement member 337 when a tip part of the movement member 337 connected to the rotation part 333 is inserted into the first holding part 331. The second holding part 332 is a member which is provided on a side wall of the support member 322 and which holds the movement member 338 when a tip part of the movement member 338 connected to the rotation part 333 is inserted into the second holding part 332.

The rotation part 333 is connected to the movement members 337 and 338, and inverts the position of the movement member 337 and the position of the movement member 338 by rotating 180° around the y-axis. The rotation part 333 includes a spring mechanism and a driving member (not illustrated). The spring mechanism and the driving member are each connected to the movement members 337 and 338. This allows each of the movement members 337 and 338 to move in a positive y-axis direction or a negative y-axis direction. The movements of the movement members 337 and 338 are controlled independently of each other. As each of the driving members, for example, an air cylinder is used.

The movement member 337 is movable along the y-axis. By being held by the first holding part 331, the movement member 337 causes the support member 312 to be held by (secured to) the inversion mechanism 33A. The movement member 338 is movable along the y-axis. By being held by the second holding part 332, the movement member 338 causes the support member 322 to be held by (secured to) the inversion mechanism 33A.

At the tip parts of the movement members 337 and 338, claw parts are provided. The claw parts each engage with a recess formed in the first holding part 331 or a recess formed in the second holding part 332, so that the movement members 337 and 338 are each held by the first holding part 331 or the second holding part 332.

The inversion mechanism 33B includes a first holding part 334, a second holding part 335, a rotation part 336, and movement members 339 and 340. The first holding part 334 is a member which is provided on a side wall of the support member 312 and which holds the movement member 339 when a tip part of the movement member 339 connected to the rotation part 336 is inserted into the first holding part 334. The second holding part 335 is a member which is provided on a side wall of the support member 322 and which holds the movement member 340 when a tip part of the movement member 340 connected to the rotation part 336 is inserted into the second holding part 335.

The rotation part 336 is connected to the movement members 339 and 340, and inverts the position of the movement member 339 and the position of the movement member 340 by rotating 180° around the y-axis. The rotation part 336 includes a spring mechanism and a driving member (not illustrated). The spring mechanism and the driving member are each connected to the movement members 339 and 340. This allows each of the movement members 339 and 340 to move in the positive y-axis direction or the negative y-axis direction. The movements of the movement members 339 and 340 are controlled independently of each other. As each of the driving members, for example, an air cylinder is used.

The movement member 339 is movable along the y-axis. By being held by the first holding part 334, the movement member 339 causes the support member 312 to be held by (secured to) the inversion mechanism 33B. The movement member 340 is movable along the y-axis. By being held by the second holding part 335, the movement member 340 causes the support member 322 to be held by (secured to) the inversion mechanism 33B.

At the tip parts of the movement members 339 and 340, claw parts are provided. The claw parts each engage with a recess formed in the first holding part 334 or a recess formed in the second holding part 335, so that the movement members 339 and 340 are each held by the first holding part 334 or the second holding part 335.

As illustrated in the reference numeral 101 in FIG. 2, when the second sandwiching part 32 has been conveyed to the position at which the inversion mechanisms 33A and 33B are provided, the first sandwiching part 31 and the second sandwiching part 32 face each other. In other words, the first elastic sheet 313 and the second elastic sheet 323 face each other. Further, the first holding parts 331 and 334 hold the movement members 337 and 339, respectively, so that the support member 312 is held by the inversion mechanisms 33A and 33B. The polysilicon S is disposed on the second elastic sheet 323.

As illustrated in the reference numeral 102 in FIG. 2, the rotation parts 333 and 336 move in the negative z-axis direction in a state where the support member 312 is held by the inversion mechanisms 33A and 33B. This brings the polysilicon S to a sandwiched state in which the polysilicon S is sandwiched between the first elastically deforming part 311 and the second elastically deforming part 321. In other words, the inversion device 3 sandwiches the polysilicon S between the first elastically deforming part 311 and the second elastically deforming part 321 (sandwiching step).

At this time, the first elastic sheet 313 and the second elastic sheet 323 elastically deforms by coming into contact with the polysilicon S in the sandwiched state. Further, the first buffer material 314 elastically deforms by coming into contact with the first elastic sheet 313 on an opposite side from the polysilicon S in the sandwiched state. The second buffer material 324 elastically deforms by coming into contact with the second elastic sheet 323 on an opposite side from the polysilicon S in the sandwiched state.

Further, a spring mechanism is connected to the movement member 338. As such, the movement of the rotation parts 333 and 336 in the negative z-axis direction causes the movement members 338 and 340 to move in the y-axis direction along surfaces of the second holding parts 332 and 335, respectively, and be inserted into the second holding parts 332 and 335, respectively. At this time, the movement member 338 is pressed in the positive y-axis direction in the recess of the second holding part 332, due to elastic force of the spring mechanism. Further, the movement member 340 is pressed in the negative y-axis direction in the recess of the second holding part 335, due to elastic force of the spring mechanism. Thus, the support member 322 is held by the inversion mechanisms 33A and 33B.

As illustrated in the reference numeral 103 in FIG. 2, the inversion mechanisms 33A and 33B hold the support member 312 with use of the movement members 337 and 339, respectively, and the inversion mechanisms 33A and 33B hold the support member 322 with use of the movement members 338 and 340, respectively. In this state, the rotation parts 333 and 336 move in the positive z-axis direction to a predetermined position. Then, the inversion mechanisms 33A and 33B respectively rotate the rotation parts 333 and 336 by 180° around the y-axis.

Thus, the inversion mechanisms 33A and 33B invert the position of the movement member 337 and the position of the movement member 338 and invert the position of the movement member 339 and the position of the movement member 340. That is, the inversion mechanisms 33A and 33B invert the position of the first holding part 331 and the position of the second holding part 332 and invert the position of the first holding part 334 and the position of the second holding part 335. Thus, the inversion mechanisms 33A and 33B invert the position of the first sandwiching part 31 and the position of the second sandwiching part 32 to thereby invert the polysilicon S (inversion step).

After the inversion mechanisms 33A and 33B invert the polysilicon S, the rotation parts 333 and 336 move in the negative z-axis direction, as illustrated in the reference numeral 104 in FIG. 3. This brings the first sandwiching part 31 to a state of being disposed on the conveyance mechanism 2. After the first sandwiching part 31 has come to a state of being disposed on the conveyance mechanism 2, the driving member causes the movement member 337 to move in the negative y-axis direction, so that the tip part of the movement member 337 is pulled out of the recess of the first holding part 331. Further, the driving member causes the movement member 339 to move in the positive y-axis direction, so that the tip part of the movement member 339 is pulled out of the recess of the first holding part 334. Thus, the inversion mechanisms 33A and 33B release the holding of the support member 312.

After the inversion mechanisms 33A and 33B release the holding of the support member 312, as illustrated in the reference numeral 105 in FIG. 3, the rotation parts 333 and 336 move in the positive z-axis direction in a state where the support member 322 is held by the inversion mechanisms 33A and 33B. This allows the conveyance mechanism 2 to convey the first sandwiching part 31 in the positive x-axis direction. As such, the conveyance mechanism 2 conveys the first sandwiching part 31 in the positive x-axis direction.

According to the above configuration, the inversion mechanisms 33A and 33B invert the polysilicon S in a sandwiched state in which the polysilicon S is sandwiched between the first elastically deforming part 311 and the second elastically deforming part 321. As such, since the first elastically deforming part 311 and the second elastically deforming part 321 deform in conformity with the shape of the polysilicon S in the sandwiched state, the inversion device 3 is able to invert polysilicon S varying in shape and/or size.

### <First Elastic Sheet 313 and Second Elastic Sheet 323>

Examples of a material of each of the first elastic sheet 313 and the second elastic sheet 323 include, but are not limited to, urethane rubber. The first elastic sheet 313 and the second elastic sheet 323 preferably each have a hardness of not less than A30 and not more than A90 in terms of Shore A hardness. The hardness of each of the first elastic sheet 313 and the second elastic sheet 323 is a result of measurement carried out with use of a durometer Type A in conformity with JIS K6253.

As described above, the shape of the polysilicon S encompasses a variety of shapes such as a flat shape and a fist-like shape. As such, among pieces of crushed polysilicon S, there can be a piece that has a sharply pointed shape. Since polysilicon has a Mohs hardness of not less than 6 and not more than 8, there is a risk that surfaces of the first elastic sheet 313 and the second elastic sheet 323 become worn or torn when the first elastic sheet 313 and the second elastic sheet 323 come into contact with the polysilicon S.

In a case where the first elastic sheet 313 and the second elastic sheet 323 each have a hardness of not less than A30 in terms of Shore A hardness, it is possible to reduce an impact caused when the first elastic sheet 313 and the second elastic sheet 323 come into contact with the polysilicon S. In addition, it is possible to retain the elasticity of each of the first elastic sheet 313 and the second elastic sheet 323. This makes it possible to prevent wear or tear of the first elastic sheet 313 and the second elastic sheet 323.

Further, in a case where the first elastic sheet 313 and the second elastic sheet 323 each have a hardness of not more than A90 in terms of Shore A hardness, it is possible for the first elastic sheet 313 and the second elastic sheet 323 to each deform into a shape which conforms with the shape of the polysilicon S and in which the first elastic sheet 313 and the second elastic sheet 323 can each stably hold the polysilicon S even at the time of inversion. This makes it possible to reliably hold the polysilicon S when the inversion mechanisms 33A and 33B invert the polysilicon S.

The first elastic sheet 313 and the second elastic sheet 323 preferably have a thickness of not less than 0.5 mm and not more than 5 mm in the z-axis direction. In a case where the first elastic sheet 313 and the second elastic sheet 323 each have a thickness of not less than 0.5 mm, it is possible to secure a wear allowance that allows the first elastic sheet 313 and the second elastic sheet 323 to be continuously used for a long period. This effect also contributes, for example, to achieving goal 12 “Ensure sustainable consumption and production patterns” and the like of the Sustainable Development Goals (SDGs) proposed by the United Nations.

Further, in a case where the first elastic sheet 313 and the second elastic sheet 323 each have a thickness of not more than 5 mm, it is possible for the first elastic sheet 313 and the second elastic sheet 323 to each deform into a shape which conforms with the shape of the polysilicon S and in which the first elastic sheet 313 and the second elastic sheet 323 can each stably hold the polysilicon S even at the time of inversion. This makes it possible to reliably hold the polysilicon S when the inversion mechanisms 33A and 33B

### <First Buffer Material 314 and Second Buffer Material 324>

Examples of a material of each of the first buffer material 314 and the second buffer material 324 include, but are not limited to, urethane foam. Some pieces of polysilicon S have a flat shape, and depending on a compression hardness of the buffer material, there is a risk that polysilicon S having a flat shape slides sideways on the first elastic sheet 313 and the second elastic sheet 323 in a case where the polysilicon S is rotated in the sandwiched state. As such, from the necessity of retaining the sandwiched state at the time of rotation of the inversion mechanisms 33A and 33B, it is preferable that the first buffer material 314 and the second buffer material 324 each have a 40% compression hardness of not less than 20 N and not more than 80 N. The 40% compression hardness of each of the first buffer material 314 and the second buffer material 324 is a result of measurement carried out in conformity with a JIS K6400-2A method.

In a case where the first buffer material 314 and the second buffer material 324 each have a 40% compression hardness of not less than 20 N, it is possible to sufficiently guarantee that, in a case where polysilicon S having a flat shape is sandwiched between the first sandwiching part 31 and the second sandwiching part 32, the polysilicon S does not slide sideways between the first elastic sheet 313 and the second elastic sheet 323 which sandwich the polysilicon S therebetween.

Further, in a case where the first buffer material 314 and the second buffer material 324 each have a 40% compression hardness of not more than 80 N, it is possible to properly absorb, with use of the first buffer material 314 and the second buffer material 324, deformation of the first elastic sheet 313 and the second elastic sheet 323 in conformity of the shape of the polysilicon S. This makes it possible to reliably hold the polysilicon S when the inversion mechanisms 33A and 33B invert the polysilicon S.

As described above, the polysilicon S ordinarily has a long diameter selected within a range of not less than 10 mm and not more than 150 mm. In a case where the first buffer material 314 and the second buffer material 324 each exhibit a high rebound resilience rate at the time of contact of polysilicon S having a large size with the first elastic sheet 313 and the second elastic sheet 323, the polysilicon S tends to bounce on the first elastic sheet 313 and the second elastic sheet 323. Further, in a case where the above rebound resilience rate is too small, deformation of the first elastic sheet 313 and the second elastic sheet 323 tends to increase.

The polysilicon S having the above size has a specific gravity of ordinarily not less than 2.2 g/cm³ and not more than 2.5 g/cm³. As such, it is preferable that a suitable rebound resilience rate of each of the first buffer material 314 and the second buffer material 324 for polysilicon S having a long diameter of approximately not less than 10 mm and approximately not more than 150 mm be not less than 1% and not more than 6%. The rebound resilience rate of each of the first buffer material 314 and the second buffer material 324 is a result of measurement carried out in conformity with JIS K6400-3.

Further, since the polysilicon S comes in contact with the first buffer material 314 and the second buffer material 324 via the first elastic sheet 313 or the second elastic sheet 323, the first buffer material 314 and the second buffer material 324 undergo less wearing at the time of the contact. As such, the first buffer material 314 is softer than the first elastic sheet 313, and the second buffer material 324 is softer than the second elastic sheet 323.

When the polysilicon S is sandwiched between the first elastically deforming part 311 and the second elastically deforming part 321, it is possible to properly absorb, with use of the first buffer material 314 and the second buffer material 324, deformation of the first elastic sheet 313 and the second elastic sheet 323 in conformity with the shape of the polysilicon S. In a case where the first buffer material 314 and the second buffer material 324 each have a rebound resilience rate of not less than 1%, it is possible, upon release of a sandwiched state in which the polysilicon S is sandwiched between the first elastically deforming part 311 and the second elastically deforming part 321, to cause respective shapes of the first buffer material 314 and the second buffer material 324 to return to those before the polysilicon S was brought into the sandwiched state.

Further, in a case where the first buffer material 314 and the second buffer material 324 each have a rebound resilience rate of not more than 6%, it is possible to prevent polysilicon S having a large size from bouncing on the first elastic sheet 313 and the second elastic sheet 323 when the polysilicon S comes into contact with the first elastic sheet 313 and the second elastic sheet 323.

A member that comes into direct contact with the polysilicon S is required to have a certain degree of hardness from the perspective of positional stability of the polysilicon S at the time of image capturing and the perspective of durability. However, in a case where the member that comes into direct contact with the polysilicon S is too hard, the member that comes into direct contact with the polysilicon S may have a poor shape conformity and be unable to hold the polysilicon S stably at the time of inversion. As such, as described above, each of the first elastically deforming part 311 and the second elastically deforming part 321 is configured to include an elastic sheet and a buffer material. This makes it possible to achieve both (i) positional stability and durability described above and (ii) shape conformity.

### <Configuration of Dome Part 7 and Image Capturing Parts 8>

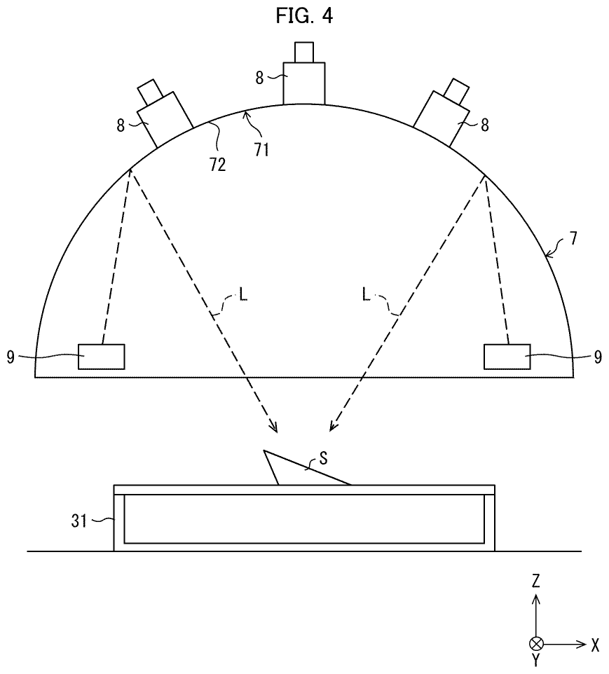

FIG. 4 is a view illustrating configurations of the dome part 7, the image capturing parts 8, and the irradiation parts 9 included in the image capturing device 1 illustrated in FIG. 1. As illustrated in FIG. 4, the dome part 7 includes a ceiling part 71 which is hemispherical and on which the image capturing parts 8 are provided. The ceiling part 71 is formed so as to protrude in the positive z-axis direction. On the ceiling part 71, the plurality of image capturing parts 8 are provided so as to make it possible to capture an image of the polysilicon S from a plurality of directions. This makes it possible to use a result of capturing an image of the polysilicon S for accurate determination of a surface state and a surface shape of the polysilicon S by the control section 10.

The plurality of image capturing parts 8 are provided in openings formed in the ceiling part 71, and are each capable of capturing an image of the polysilicon S inverted by the inversion mechanisms 33A and 33B. As illustrated in FIG. 1, for example, when the dome part 7 is viewed in the negative z-axis direction, it is possible to provide a single image capturing part 8 at a top of the dome part 7 and provide eight image capturing parts 8 such that the eight image capturing parts 8 are arranged in an annular shape around the single image capturing part 8. It is preferable that the eight image capturing parts 8 be provided such that a direction in which each of the eight imaging parts 8 captures an image is a direction that is inclined by 30° with respect to the z-axis direction.

The conveyance mechanism 2 conveys the first sandwiching part 31, on which the polysilicon S is disposed, from the position at which the polysilicon S is inverted by the inversion mechanisms 33A and 33B to a second image capturing position. The position at which the polysilicon S is inverted by the inversion mechanisms 33A and 33B is a position at which the inversion mechanisms 33A and 33B are disposed on the conveyance mechanism 2.

The second image capturing position is a position which is below the dome part 7 and at which the plurality of image capturing parts 8 can each capture an image of the polysilicon S. The plurality of image capturing parts 8 each capture an image of the polysilicon S which has been conveyed from the position at which the polysilicon S was inverted by the inversion mechanisms 33A and 33B to the second image capturing position (image capturing step).

As means for capturing an image of the polysilicon S, an image capturing means that is capable of recognizing a shape of the entirety of the polysilicon S and a surface state of the polysilicon S can be employed. Specifically, it is possible to employ an image capturing means such as capturing of a still image or a moving image with use of a charge coupled device (CCD) camera.

Adjustment is made for an image of the polysilicon S captured by each of the image capturing parts 5 and 8 such that an image quality achieved allows identification of a pore of not more than 1 mm that is present on the surface of the polysilicon S. Specifically, an angle of view and a subject distance are adjusted such that a width of the image is not less than 1.2 times and not more than 5.0 times as large as the maximum size of the polysilicon S. Further, the number of pixels with which an image of the polysilicon S is captured is not less than 2 million pixels.

After images of the polysilicon S are captured by the plurality of image capturing parts 8, the conveyance mechanism 2 conveys the first sandwiching part 31, on which the polysilicon S is disposed, to a place at which separation of polysilicon S is carried out. At this time, the conveyance mechanism 2 conveys the first sandwiching part 31 in the positive x-axis direction. At the place at which separation of polysilicon S is carried out, separation of the polysilicon S is carried out on the basis of a result of classification of the polysilicon S which has been carried out by a server 11 (described later).

With the above configuration, the inversion mechanisms 33A and 33B are able to invert the polysilicon S in a sandwiched state, and the image capturing parts 8 are each able to capture an image of the polysilicon S inverted by the inversion mechanisms 33A and 33B. This allows the image capturing device 1 to capture an image of polysilicon S varying in shape and/or size and to capture an image of polysilicon S which has been inverted.

### <Configuration of Irradiation Parts 9>

The plurality of irradiation parts 9 are light sources provided in positions that are below an inner surface 72 of the ceiling part 71 of the dome part 7 and that are within a space surrounded by the inner surface 72. The plurality of irradiation parts 9 irradiate the inner surface 72 with light L so that the light L is reflected by the inner surface 72 and emitted toward a position below the dome part 7. The inner surface 72 is composed of a material capable of reflecting the light L. As illustrated in FIG. 1, for example, when the dome part 7 is viewed in the negative z-axis direction, six irradiation parts 9 may be provided in the vicinity of an outer periphery of the dome part 7.

With the above configuration, it is possible to dispose polysilicon S that has been inverted in the second image capturing position and, with use of the irradiation parts 9, irradiate the polysilicon S positioned at the second image capturing position with the light L reflected by the inner surface 72 of the ceiling part 71 of the dome part 7. This allows the image capturing device 1 to capture a clear image of the polysilicon S which has been inverted.

### <Configurations of Dome Part 4, Image Capturing Parts 5, and Irradiation Parts 6>

The configurations of the dome part 4, the image capturing parts 5, and the irradiation parts 6 illustrated in FIG. 1 are respectively similar to those of the dome part 7, the image capturing parts 8, and the irradiation parts 9. The plurality of image capturing parts 5 are each capable of capturing an image of the polysilicon S conveyed by the conveyance mechanism 2. The conveyance mechanism 2 conveys the second sandwiching part 32, on which the polysilicon S is disposed, to the first image capturing position. The first image capturing position is a position which is below the dome part 4 and at which the plurality of image capturing parts 5 can each capture an image of the polysilicon S.

The plurality of image capturing parts 5 each capture an image of the polysilicon S which has been conveyed to the first image capturing position and which has not been inverted by the inversion mechanisms 33A and 33B. After images of the polysilicon S are captured by the plurality of image capturing parts 5, the conveyance mechanism 2 conveys the second sandwiching part 32, on which the polysilicon S is disposed, to a position at which the inversion mechanisms 33A and 33B are disposed on the conveyance mechanism 2.

### <Configuration of Control Section 10>

The control section 10 may be a control device capable of controlling the conveyance mechanism 2, the inversion device 3, the image capturing parts 5 and 8, and the irradiation parts 6 and 9, and is, for example, a central processing unit (CPU). The control section 10 may also be a device that includes such a control device and that further includes: a storage device such as a memory; and a communication device or the like capable of communicating with the server 11.

The control section 10 acquires captured images which have been captured by the plurality of image capturing parts 5 and the plurality of image capturing parts 8. The control section 10 transmits the acquired captured images to the server 11. By referring to the captured images received from the control section 10, the server 11 determines at least one feature of the polysilicon S selected from the group consisting of porosity, cracks, pores, stains, rod diameter, and surface shape. The server 11 carries out classification of the polysilicon S on the basis of the at least one feature. The rod diameter is a diameter of a rod in a case where the polysilicon S is formed in a shape of the rod.

Note that the control section 10, rather than the server 11, may carry out classification of the polysilicon S. In this case, the control section 10 determines the at least one feature by referring to the acquired captured images. Further, the control section 10 carries out classification of the polysilicon S on the basis of the at least one feature.

### [Variations]

In a sandwiched state in which polysilicon S is sandwiched between the first sandwiching part 31 and the second sandwiching part 32, the first sandwiching part 31 and the second sandwiching part 32 may be conveyed to the position at which the inversion mechanisms 33A and 33B are provided, and the inversion mechanisms 33A and 33B may invert the polysilicon S in the sandwiched state. This will be discussed in detail below.

The following considers a case in which images of the polysilicon S are captured by the plurality of image capturing parts 5 and then the second sandwiching part 32 on which the polysilicon S is disposed is conveyed by the conveyance mechanism 2 in the positive x-axis direction. In this case, the first sandwiching part 31 may be disposed on the second sandwiching part 32 and the polysilicon S by a mechanism (not illustrated) at a position between the dome part 4 and the inversion mechanisms 33A and 33B. At this time, the first elastic sheet 313 and the second elastic sheet 323 face each other, and the polysilicon S is in a sandwiched state in which the polysilicon S is sandwiched between the first sandwiching part 31 and the second sandwiching part 32.

After the polysilicon S has come to the sandwiched state, the conveyance mechanism 2 conveys the first sandwiching part 31 and the second sandwiching part 32 in the sandwiched state to the position at which the inversion mechanisms 33A and 33B are provided on the conveyance mechanism 2. Then, the rotation parts 333 and 336 illustrated in FIG. 2 move in the negative z-axis direction, so that the movement members 337 and 339 are inserted into the first holding parts 331 and 334, respectively. Thus, the inversion mechanisms 33A and 33B hold the support member 312 of the first sandwiching part 31. Further, the movement members 338 and 340 are inserted into the second holding parts 332 and 335, respectively. Thus, the inversion mechanisms 33A and 33B hold the support member 322 of the second sandwiching part 32.

Then, the rotation parts 333 and 336 move in the positive z-axis direction, and the inversion mechanisms 33A and 33B respectively rotate the rotation parts 333 and 336 by 180° around the y-axis to thereby invert the polysilicon S. After the inversion mechanisms 33A and 33B invert the polysilicon S, the rotation parts 333 and 336 move in the negative z-axis direction. This brings the first sandwiching part 31 to a state of being disposed on the conveyance mechanism 2.

After the first sandwiching part 31 has come to a state of being disposed on the conveyance mechanism 2, the movement members 337 and 339 move so that the respective tip parts of the movement members 337 and 339 are farther from the first holding parts 331 and 334. Thus, the inversion mechanisms 33A and 33B release the holding of the support member 312. Further, the movement members 338 and 340 move so that the respective tip parts of the movement members 338 and 340 are farther from the second holding parts 332 and 335. Thus, the inversion mechanisms 33A and 33B release the holding of the support member 322.

After the holding of the support members 312 and 322 is released, the conveyance mechanism 2 conveys the first sandwiching part 31 and the second sandwiching part 32 in the positive x-axis direction in the sandwiched state. Then, at a position between the inversion mechanisms 33A and 33B and the dome part 7, the second sandwiching part 32 may be removed from the first sandwiching part 31 by a mechanism that is not illustrated. After the second sandwiching part 32 is removed, the conveyance mechanism 2 conveys the first sandwiching part 31, on which the polysilicon S is disposed, to the second image capturing position.

### Embodiment 2

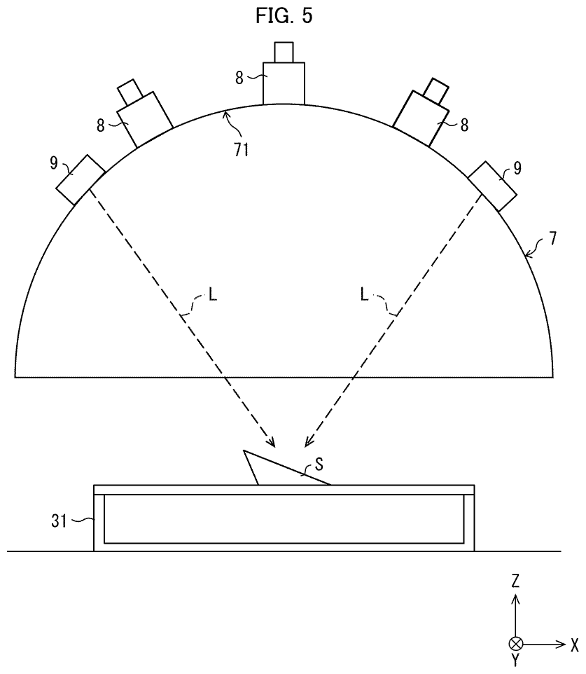

The following description will discuss Embodiment 2 of the present invention. For the convenience of description, a member having the same function as the member already described in Embodiment 1 is assigned the same reference numeral, and the description of the member is omitted. FIG. 5 is a view illustrating configurations of a dome part 7, image capturing parts 8, and irradiation parts 9 included in an image capturing device in accordance with Embodiment 2 of the present invention.

The image capturing device in accordance with Embodiment 2 differs from the image capturing device 1 in accordance with Embodiment 1 in positions at which the irradiation parts 9 are provided, as illustrated in FIG. 5. The plurality of irradiation parts 9 are provided in openings formed in a ceiling part 71, and each emit light L toward a position below the dome part 7. In other words, the plurality of irradiation parts 9 directly irradiate polysilicon S, which has been inverted by inversion mechanisms 33A and 33B, with light L. For example, when the dome part 7 is viewed in a negative z-axis direction, six irradiation parts 9 may be provided so as to be arranged in an annular shape around the plurality of image capturing parts 8.

With the above configuration, it is possible to dispose polysilicon S that has been inverted in a second image capturing position which is below the dome part 7, and directly irradiate the polysilicon S positioned at the second image capturing position with light L. This allows the image capturing device in accordance with Embodiment 2 to capture a clear image of the polysilicon S which has been inverted.

Note that the dome part 7 may include both (i) irradiation parts 9 which are provided, for example, as illustrated in FIG. 4 and which indirectly irradiate the polysilicon S with light L and (ii) irradiation parts 9 which are provided, for example, as illustrated in FIG. 5 and which directly irradiate the polysilicon S with light L.

### Embodiment 3

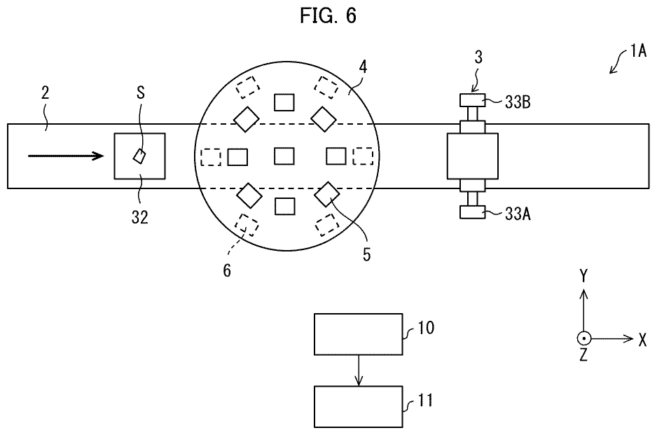

The following description will discuss Embodiment 3 of the present invention. For the convenience of description, a member having the same function as the member already described in Embodiment 1 is assigned the same reference numeral, and the description of the member is omitted. FIG. 6 is a view schematically illustrating a configuration of an image capturing device 1A in accordance with Embodiment 3 of the present invention.

As illustrated in FIG. 6, the image capturing device 1A differs from the image capturing device 1 in accordance with Embodiment 1 in that the image capturing device 1A includes no dome part 7, no image capturing parts 8, and no irradiation parts 9. A plurality of image capturing parts 5 are each capable of capturing an image of polysilicon S conveyed by a conveyance mechanism 2. The conveyance mechanism 2 conveys a second sandwiching part 32, on which the polysilicon S is disposed, to a first image capturing position. The first image capturing position is a position which is below a dome part 4 and at which the plurality of image capturing parts 5 can each capture an image of the polysilicon S.

The plurality of image capturing parts 5 each capture an image of the polysilicon S which has been conveyed to the first image capturing position and which has not been inverted by the inversion mechanisms 33A and 33B. After images of the polysilicon S are captured by the plurality of image capturing parts 5, the conveyance mechanism 2 conveys the second sandwiching part 32, on which the polysilicon S is disposed, to a position at which the inversion mechanisms 33A and 33B are disposed on the conveyance mechanism 2. At this time, the conveyance mechanism 2 conveys the second sandwiching part 32 in a positive x-axis direction.

After the second sandwiching part 32 on which the polysilicon S is disposed is conveyed to the position at which the inversion mechanisms 33A and 33B are disposed on the conveyance mechanism 2, the inversion mechanisms 33A and 33B invert the position of the first sandwiching part 31 and the position of the second sandwiching part 32, so that the polysilicon S is inverted. After the polysilicon S is inverted by the inversion mechanisms 33A and 33B, the conveyance mechanism 2 conveys the first sandwiching part 31, on which the polysilicon S is disposed, to the first image capturing position. At this time, the conveyance mechanism 2 conveys the first sandwiching part 31 in a negative x-axis direction.

The plurality of image capturing parts 5 each capture an image of the polysilicon S which has been conveyed to the first image capturing position and which has been inverted by the inversion mechanisms 33A and 33B. After images of the polysilicon S are captured by the plurality of image capturing parts 5, the conveyance mechanism 2 conveys the first sandwiching part 31, on which the polysilicon S is disposed, to a place at which separation of polysilicon S is carried out. At this time, the conveyance mechanism 2 conveys the first sandwiching part 31 in the positive x-axis direction.

Aspects of the present invention can also be expressed as follows:

An inversion device in accordance with Aspect 1 of the present invention includes: a first sandwiching part including a first elastically deforming part that elastically deforms; a second sandwiching part including a second elastically deforming part that elastically deforms; and an inversion mechanism that, in order to capture an image of polysilicon, inverts the polysilicon in a sandwiched state in which the polysilicon is sandwiched between the first elastically deforming part and the second elastically deforming part.

An inversion device in accordance with Aspect 2 of the present invention may be configured such that, in Aspect 1, (i) the first elastically deforming part includes a first elastic sheet that elastically deforms by coming into contact with the polysilicon in the sandwiched state and a first buffer material that is softer than the first elastic sheet and elastically deforms by coming into contact with the first elastic sheet on an opposite side from the polysilicon in the sandwiched state and (ii) the second elastically deforming part includes a second elastic sheet that elastically deforms by coming into contact with the polysilicon in the sandwiched state and a second buffer material that is softer than the second elastic sheet and elastically deforms by coming into contact with the second elastic sheet on an opposite side from the polysilicon in the sandwiched state.

An inversion device in accordance with Aspect 3 of the present invention may be configured such that, in Aspect 2, the first elastic sheet and the second elastic sheet each have a hardness of not less than A30 and not more than A90 in terms of Shore A hardness.

An inversion device in accordance with Aspect 4 of the present invention may be configured such that, in Aspect 2 or 3, the first elastic sheet and the second elastic sheet each have a thickness of not less than 0.5 mm and not more than 5 mm.

An inversion device in accordance with Aspect 5 of the present invention may be configured such that, in any one of Aspects 2 to 4, the first buffer material and the second buffer material each have a 40% compression hardness of not less than 20 N and not more than 80 N.

An inversion device in accordance with Aspect 6 of the present invention may be configured such that, in any one of Aspects 2 to 5, the first buffer material and the second buffer material each have a rebound resilience rate of not less than 1% and not more than 6%.

An image capturing device in accordance with Aspect 7 of the present invention includes: a first sandwiching part including a first elastically deforming part that elastically deforms; a second sandwiching part including a second elastically deforming part that elastically deforms; an inversion mechanism that inverts polysilicon in a sandwiched state in which the polysilicon is sandwiched between the first elastically deforming part and the second elastically deforming part; and an image capturing part capable of capturing an image of the polysilicon inverted by the inversion mechanism.

An image capturing device in accordance with Aspect 8of the present invention may be configures such that, in Aspect 7, the image capturing device further includes: a dome part including a ceiling part which is hemispherical and on which the image capturing part is provided; and an irradiation part that is at least one selected from the group consisting of (i) an irradiation part that irradiates an inner surface of the ceiling part of the dome part with light so that the light is reflected by the inner surface and emitted toward a position below the dome part and (ii) an irradiation part that emits light toward the position below the dome part, wherein the image capturing part captures an image of the polysilicon which has been conveyed from a position at which the polysilicon is inverted by the inversion mechanism to an image capturing position.

An image capturing device in accordance with Aspect 9 of the present invention may be configured such that, in Aspect 7 or 8, a plurality of image capturing parts are provided in order to make it possible to capture an image of the polysilicon from a plurality of directions, each of the plurality of image capturing parts being the image capturing part.

An inversion method in accordance with Aspect 10 of the present invention is a method which includes: a sandwiching step of sandwiching polysilicon between a first elastically deforming part that is included in a first sandwiching part and elastically deforms and a second elastically deforming part that is included in a second sandwiching part and elastically deforms; and an inversion step of, in order to capture an image of the polysilicon, inverting the polysilicon in a sandwiched state in which the polysilicon is sandwiched by the sandwiching step.

An image capturing method in accordance with Aspect 11 of the present invention is a method which includes: a sandwiching step of sandwiching polysilicon between a first elastically deforming part that is included in a first sandwiching part and elastically deforms and a second elastically deforming part that is included in a second sandwiching part and elastically deforms; an inversion step of inverting the polysilicon in a sandwiched state in which the polysilicon is sandwiched by the sandwiching step; and an image capturing step of capturing an image of the polysilicon inverted by the inversion step.

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1, 1A: Image capturing device
4, 7: Dome part
5, 8: Image capturing part
6, 9: Irradiation part
31: First sandwiching part
32: Second sandwiching part
33A, 33B: Inversion mechanism
71: Ceiling part
72: Inner surface
311: First elastically deforming part
313: First elastic sheet
314: First buffer material
321: Second elastically deforming part
323: Second elastic sheet
324: Second buffer material
S: Polysilicon

1. An inversion device, comprising:
a first sandwiching part including a first elastically deforming part that elastically deforms;
a second sandwiching part including a second elastically deforming part that elastically deforms; and
an inversion mechanism that, in order to capture an image of a crushed piece of polysilicon, inverts the crushed piece of polysilicon in a sandwiched state in which the crushed piece of polysilicon is sandwiched between the first elastically deforming part and the second elastically deforming part.

2. The inversion device as set forth in claim 1, wherein:
the first elastically deforming part includes
a first elastic sheet that elastically deforms by coming into contact with the crushed piece of polysilicon in the sandwiched state and
a first buffer material that is softer than the first elastic sheet and elastically deforms by coming into contact with the first elastic sheet on an opposite side from the crushed piece of polysilicon in the sandwiched state; and
the second elastically deforming part includes
a second elastic sheet that elastically deforms by coming into contact with the crushed piece of polysilicon in the sandwiched state and
a second buffer material that is softer than the second elastic sheet and elastically deforms by coming into contact with the second elastic sheet on an opposite side from the crushed piece of polysilicon in the sandwiched state.

3. The inversion device as set forth in claim 2, wherein the first elastic sheet and the second elastic sheet each have a hardness of not less than A30 and not more than A90 in terms of Shore A hardness.

4. The inversion device as set forth in claim 2, wherein the first elastic sheet and the second elastic sheet each have a thickness of not less than 0.5 mm and not more than 5 mm.

5. The inversion device as set forth in claim wherein the first buffer material and the second buffer material each have a 40% compression hardness of not less than 20 N and not more than 80 N.

6. The inversion device as set forth in claim 2, wherein the first buffer material and the second buffer material each have a rebound resilience rate of not less than 1% and not more than 6%.

7. An image capturing device, comprising:
a first sandwiching part including a first elastically deforming part that elastically deforms;
a second sandwiching part including a second elastically deforming part that elastically deforms;
an inversion mechanism that inverts a crushed piece of polysilicon in a sandwiched state in which the crushed piece of polysilicon is sandwiched between the first elastically deforming part and the second elastically deforming part; and
an image capturing part capable of capturing an image of the crushed piece of polysilicon inverted by the inversion mechanism.

8. The image capturing device as set forth in claim 7, further comprising:
a dome part including a ceiling part which is hemispherical and on which the image capturing part is provided; and
an irradiation part that is at least one selected from the group consisting of (i) an irradiation part that irradiates an inner surface of the ceiling part of the dome part with light so that the light is reflected by the inner surface and emitted toward a position below the dome part and (ii) an irradiation part that emits light toward the position below the dome part, wherein the image capturing part captures an image of the crushed piece of polysilicon which has been conveyed from a position at which the crushed piece of polysilicon is inverted by the inversion mechanism to an image capturing position.

9. The image capturing device as set forth in claim wherein a plurality of image capturing parts are provided in order to make it possible to capture an image of the crushed piece of polysilicon from a plurality of directions, each of the plurality of image capturing parts being the image capturing part.

10. An inversion method, comprising:
a sandwiching step of sandwiching a crushed piece of polysilicon between a first elastically deforming part that is included in a first sandwiching part and elastically deforms and a second elastically deforming part that is included in a second sandwiching part and elastically deforms; and
an inversion step of, in order to capture an image of the crushed piece of polysilicon, inverting the crushed piece of polysilicon in a sandwiched state in which the crushed piece of polysilicon is sandwiched by the sandwiching step.

11. An image capturing method, comprising:
a sandwiching step of sandwiching a crushed piece of polysilicon between a first elastically deforming part that is included in a first sandwiching part and elastically deforms and a second elastically deforming part that is included in a second sandwiching part and elastically deforms;
an inversion step of inverting the crushed piece of polysilicon in a sandwiched state in which the crushed piece of polysilicon is sandwiched by the sandwiching step; and
an image capturing step of capturing an image of the crushed piece of polysilicon inverted by the inversion step.
